(19) United States
(12) Patent Application Publication
(10) Pub. No.: US 2017/0085704 A1
(43) Pub. Date: Mar. 23, 2017

(54) SECURITY METHOD AND SYSTEM FOR INTER-NODAL COMMUNICATION FOR VoIP LAWFUL INTERCEPTION

(71) Applicant: NOKIA SOLUTIONS AND NETWORKS OY, Espoo (FI)

(72) Inventors: Nagaraja RAO, Boca Raton, FL (US); Gabor UNGVARI, Gyal (HU)

(21) Appl. No.: 15/116,420

(22) PCT Filed: Feb. 3, 2014
(86) PCT No.: PCT/US14/14427

§ 371 Date: Aug. 3, 2016

(51) Int. Cl. H04M 3/22; H04L 29/06; H04M 3/42; H04M 7/00

(52) U.S. Cl. CPC H04M 3/2281; H04M 7/0078; H04L 65/1016; H04L 65/1096; H04M 3/42102; H04M 3/42059

(57) ABSTRACT

Systems, methods, apparatuses, and computer program products for security of inter-nodal communication for VoiP lawful interception are provided. One method includes receiving, by an access node, at least one identity from an internet protocol multimedia system (IMS) node, the at least one identity used by the IMS node to intercept signaling messages, compiling a target list comprising the at least one identity, receiving a message from the IMS node when a session is established, wherein the message comprises an identity for each of the parties to the session, and comparing the identity for each of the parties to the session with the at least one identity in the target list.

### BACKGROUND

Field

Embodiments of the invention generally relate to wireless communications networks, such as, but not limited to, the Universal Mobile Telecommunications System (UMTS) Terrestrial Radio Access Network (UTRAN) Long Term Evolution (LTE) and Evolved UTRAN (E-UTRAN). Some embodiments may specifically relate to interception and particularly but not exclusively to the lawful interception of data in communications networks.

Description of the Related Art

A communication system can be seen as a facility that enables communications between two or more entities such as a communication device, e.g. mobile stations (MS) or user equipment (UE), and/or other network elements or nodes, e.g. Node B or base transceiver station (BTS), associated with the communication system. A communication system typically operates in accordance with a given standard or specification which sets out what the various entities associated with the communication system are permitted to do and how that should be achieved.

Wireless communication systems include various cellular or otherwise mobile communication systems using radio frequencies for sending voice or data between stations, for example between a communication device and a transceiver network element. Examples of wireless communication systems may comprise public land mobile network (PLMN), such as global system for mobile communication (GSM), the general packet radio service (GPRS) and the universal mobile telecommunications system (UMTS).

A mobile communication network may logically be divided into a radio access network (RAN) and a core network (CN). The core network entities typically include various control entities and gateways for enabling communication via a number of radio access networks and also for interfacing a single communication system with one or more communication systems, such as with other wireless systems, such as a wireless Internet Protocol (IP) network, and/or fixed line communication systems, such as a public switched telephone network (PSTN). Examples of radio access networks may comprise the UMTS terrestrial radio access network (UTRAN) and the GSM/EDGE radio access network (GERAN).

A geographical area covered by a radio access network is divided into cells defining a radio coverage provided by a transceiver network element, such as a Node B. A single transceiver network element may serve a number of cells. A plurality of transceiver network elements is typically connected to a controller network element, such as a radio network controller (RNC). The logical interface between an RNC and a Node B, as defined by the 3^{rd} Generation Partnership Project (3GPP), is called an Iub interface.

A UE or MS may be provided with access to applications supported by the core network via the radio access network. In some instances a packet data protocol context may be set up to provide traffic flows between the application layer on the user equipment and the application supported by the core network.

Long Term Evolution (LTE) refers to improvements of the UMTS through improved efficiency and services, lower costs, and use of new spectrum opportunities. In particular, LTE is a 3rd Generation Partnership Project (3GPP) standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD).

As mentioned above, LTE improves spectral efficiency in communication networks, allowing carriers to provide more data and voice services over a given bandwidth. Therefore, LTE is designed to fulfill the need for high-speed data and media transport in addition to high-capacity voice support. Advantages of LTE include high throughput, low latency, FDD and TDD support in the same platform, an improved end-user experience, and a simple architecture resulting in low operating costs. In addition, LTE is an all internet protocol (IP) based network, supporting both IPv4 and IPv6.

A requirement of some networks is the provision of lawful interception capabilities. In lawful interception, communication data on the network is intercepted and provided to a lawful authority. The lawful authority can analyze the data with regards to any lawful issues that may arise.

### SUMMARY

One embodiment is directed to a method that includes receiving, by an access node, at least one identity from an internet protocol multimedia system (IMS) node, the at least one identity used by the IMS node to intercept signaling messages. The method may then include compiling a target list comprising the at least one identity, and receiving a message from the IMS node when a session is established. The message may include an identity for each of the parties to the session. The method may further include comparing the identity for each of the parties to the session with the at least one identity in the target list, and when there is a match between any of the identity for each of the parties to the session and any one of the at least one identity in the target list, intercepting call content of the session.

Another embodiment is directed to an apparatus which may include at least one processor and at least one memory including computer program code. The at least one memory and the computer program code may be configured, with the at least one processor, to cause the apparatus at least to receive at least one identity from an internet protocol multimedia system (IMS) node. The at least one identity may be used by the IMS node to intercept signaling messages. The at least one memory and the computer program code may be further configured, with the at least one processor, to cause the apparatus at least to compile a target list comprising the at least one identity, and receive a message from the IMS node when a session is established. The message may include an identity for each of the parties to the session. The at least one memory and the computer program code may be further configured, with the at least one processor, to cause the apparatus at least to compare the identity for each of the parties to the session with the at least one identity in the target list, and when there is a match between any of the identity for each of the parties to the session and any one of the at least one identity in the target list, to intercept call content of the session.

Another embodiment is directed to an apparatus including means for receiving at least one identity from an internet protocol multimedia system (IMS) node, where the at least one identity may be used by the IMS node to intercept signaling messages. The apparatus may further include means for compiling a target list comprising the at least one identity, and means for receiving a message from the IMS node when a session is established. The message may include an identity for each of the parties to the session. The apparatus may further include means for comparing the identity for each of the parties to the session with the at least one identity in the target list, and when there is a match between any of the identity for each of the parties to the session and any one of the at least one identity in the target list, means for intercepting call content of the session.

Another embodiment is directed to a computer program product, embodied on a computer readable medium. The computer program product may be configured to control a processor to perform a method including receiving, by an access node, at least one identity from an internet protocol multimedia system (IMS) node, the at least one identity used by the IMS node to intercept signaling messages. The method may then include compiling a target list comprising the at least one identity, and receiving a message from the IMS node when a session is established. The message may include an identity for each of the parties to the session. The method may further include comparing the identity for each of the parties to the session with the at least one identity in the target list, and when there is a match between any of the identity for each of the parties to the session and any one of the at least one identity in the target list, intercepting call content of the session.

Another embodiment is directed to a method including providing, by an internet protocol multimedia system (IMS) node, at least one identity used in the IMS to intercept signaling messages to one or more access nodes, and informing at least one of the one or more access nodes when a session is established. The informing may include sending a message to the at least one of the one or more access nodes, where the message includes an identity for each of the parties to the session.

Another embodiment is directed to an apparatus which may include at least one processor and at least one memory including computer program code. The at least one memory and the computer program code may be configured, with the at least one processor, to cause the apparatus at least to provide, to one or more access nodes, at least one identity used in an internet protocol multimedia system (IMS) to intercept signaling messages, and to inform at least one of the one or more access nodes when a session is established. The informing may include sending a message to the at least one of the one or more access nodes, where the message may include an identity for each of the parties to the session.

Another embodiment is directed to an apparatus including means for providing at least one identity used in an internet protocol multimedia system (IMS) to intercept signaling messages to one or more access nodes, and means for informing at least one of the one or more access nodes when a session is established. The means for informing may include means for sending a message to the at least one of the one or more access nodes, where the message includes an identity for each of the parties to the session.

Another embodiment is directed to a computer program product, embodied on a computer readable medium. The computer program product may be configured to control a processor to perform a method including providing, by an internet protocol multimedia system (IMS) node, at least one identity used in the IMS to intercept signaling messages to one or more access nodes, and informing at least one of the one or more access nodes when a session is established. The informing may include sending a message to the at least one of the one or more access nodes, where the message includes an identity for each of the parties to the session.

### BRIEF DESCRIPTION OF THE DRAWINGS

For proper understanding of the invention, reference should be made to the accompanying drawings, wherein:

FIG. 1a illustrates a system according to an embodiment;

FIG. 1b illustrates a system according to another embodiment;

FIG. 2 illustrates a system according to another embodiment;

FIG. 3 illustrates a system according to another embodiment;

FIG. 4 illustrates a system according to another embodiment;

FIG. 5 illustrates a system according to another embodiment;

FIG. 6 illustrates a system according to another embodiment;

FIG. 7 illustrates a system according to another embodiment;

FIG. 8 illustrates a system according to another embodiment;

FIG. 9 illustrates a call flow diagram according to one embodiment;

FIG. 10 illustrates a call flow diagram according to another embodiment;

FIG. 11 illustrates a call flow diagram according to another embodiment;

FIG. 12a illustrates an apparatus according to one embodiment;

FIG. 12b illustrates an apparatus according to another embodiment;

FIG. 13 illustrates a flow diagram of a method according to one embodiment; and

FIG. 14 illustrates a flow diagram of a method according to another embodiment.

### DETAILED DESCRIPTION

It will be readily understood that the components of the invention, as generally described and illustrated in the figures herein, may be arranged and designed in a wide variety of different configurations. Thus, the following detailed description of the embodiments of systems, methods, apparatuses, and computer program products for security of inter-nodal communication for VoIP lawful interception, as represented in the attached figures, is not intended to limit the scope of the invention, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments. Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

As will be discussed in detail below, certain embodiments of the invention relate to lawful interception (LI), which, in the United States, is covered under the Communications Assistant for Law Enforcement Act (CALEA). Some embodiments are directed to lawful interception of VoIP calls (e.g., VoLTE). Lawful interception (LI) is a legally authorized process by which a Communication Service Provider (CSP), usually a mobile network operator, is required to provide law enforcement or government agencies with access to the communication of private individuals. This interception process is strongly regulated by national laws and telecommunication acts in each country/region, such as the aforementioned CALEA.

The network has well defined interfaces to provide the intercepted communication and the interception related information towards the intercepting authority. The 3GPP TS 33.107 and TS 33.108 define LI configuration, internal and external LI interface for 3GPP network architectures and 3GPP defined services. The Alliance for Telecommunications Industry Solutions (ATIS) Standards in North America define the external LI interface to networks deployed in North America.

One of the important aspects of LI functions is security—the fact that a lawful interception is happening on a particular target private individual should not be disclosed to unauthorized personnel. The authorized personnel may include the intercepting authority and the special CSP personnel who have a security clearance to manage the interception-related data on the CSP's network. Unauthorized personnel may include, for example, the target private individual, other individuals with whom the target private individual is in communication with, other authorities, and CSP personnel who do not have authorization to manage the intercept-related data. Where applicable, the published standards do provide some guidelines on these aspects.

With VoIP, the network access functions that intercept the communication traffic can consist of multiple network nodes. One network node that provides a part of the intercept functions may have to interact with another network node that provides another part of the intercept functions. Embodiments of the invention provide a mechanism to allow one network node to interact with another network node on the interception without ever allowing a third party to know about it.

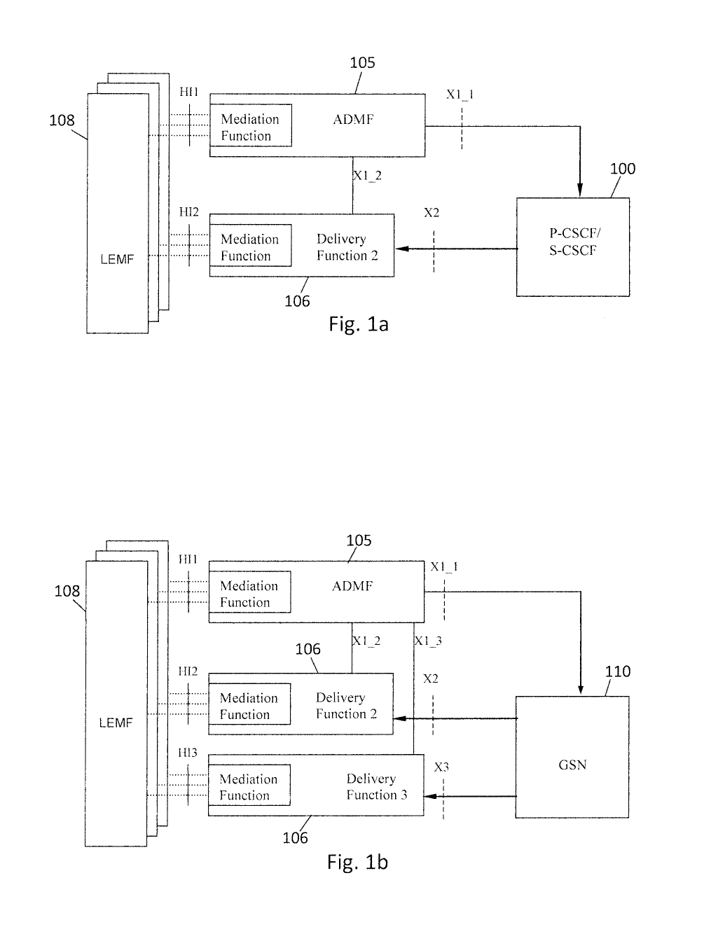

As mentioned above, with VoIP, several network nodes may be involved in providing the lawful interception functions. 3GPP specifications TS 33.107 and 33.108 define the capabilities for the interception of IP multimedia system (IMS) signalling messages at the IMS nodes, such as proxy call state control function (P-CSCF) or serving call state control function (S-CSCF) 100, and presume that the content interception is done at the packet core networks. FIG. 1 illustrates examples of lawful interception architectures.

FIG. 1a illustrates an example of an IMS-CSCF intercept configuration. In this example, there is one Administration Function (ADMF) 105 in the network. Together with the delivery function(s) 106, ADMF 105 is used to hide from the intercepting control elements (ICEs) that there might be multiple activations by different Law Enforcement Monitoring Facilities (LEMFs) 108 on the same target. ADMF 105 may be partitioned to ensure separation of the provisioning data from different agencies. In the example of FIG. 1a, the provision of intercept related information (IRI) for session initiation protocol (SIP) messages may be handled by P-CSCF/S-CSCF 100.

FIG. 1b illustrates an example of a packet switched intercept configuration. In this example, there is again one Administration Function (ADMF) 105 in the network. As mentioned above, along with the delivery function(s) 106, ADMF 105 is used to hide from the intercepting control elements (ICEs) that there might be multiple activations by different Law Enforcement Monitoring Facilities (LEMFs) 108 on the same target. In this example, interception of the content of communication (CC) may be done at the GPRS support node (GSN) 110 under a separate activation and invocation.

Mediation functions, which may be transparent or part of the administration function 105 and delivery function(s) 106, are used to convert information on the HI1, HI2 and HI3 interfaces into the format described in various national or regional specifications.

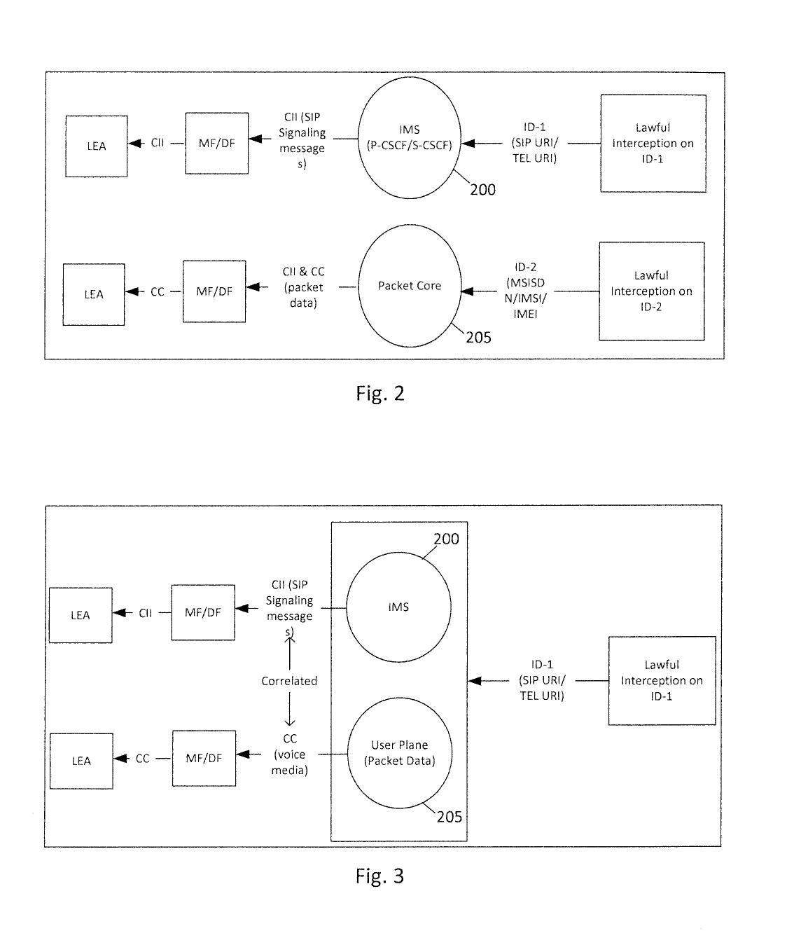

The identity used within the IMS network to handle the SIP sessions is different from the identities used in the packet core network. Accordingly, the signalling messages of a target subscriber can be isolated in the IMS using the identities used to handle SIP sessions (e.g., SIP uniform resource identifier (URI) or telephone (TEL) URI). The packet data of a target subscriber can be isolated in the packet core network using the identities used therein (e.g., Mobile Subscriber Integrated Services Data Network Number (MSISDN)/International Mobile Subscriber Identity (IMSI)/International Mobile Equipment Identity (IMEI)). A lawful interception of a VoIP call as per the lawful interception architecture defined in 3GPP specifications require the interception in IMS for SIP signalling messages and the interception in packet core for voice communication traffic. In other words, as depicted in FIG. 2, the interception of a VoIP call requires the use of separate identities—one for IMS 200 and one for Packet Core 205.

FIG. 2 also illustrates that the packet data intercepted in the Packet Core Network includes not only the voice communication traffic but also the other packet data such as SIP signalling messages, internet traffic, etc. Furthermore, the interception of a VoIP call requires the interception to continue when an incoming call to the target subscriber gets forwarded. However, the packet core network that serves the forwarded-to subscriber may not be aware of the target subscriber's identities and thus the interception of voice communication traffic of a forwarded call may not happen.

The LEA may have only the voice service level identity (e.g., SIP URI or TEL URI) to request the interception for a VoIP call. In other words, the lawful interception of a VoIP call should use just one identity used to establish the VoIP sessions (e.g., SIP URI or TEL URI) and should intercept just the voice communication traffic. Furthermore, the SIP signalling messages delivered to the LEA (as call identifying information (CII)) and the voice communication traffic delivered to the LEA (as CC) need to be correlated. FIG. 3 illustrates an example of such correlation between the CII and CC. This may require a real time communication between the IMS and the packet core network without compromising the security requirements discussed above.

In view of the above, certain embodiments of the invention assume the following as requirements of lawful interception for a VoIP call: 1) one identity to identify the target individual subscriber; 2) intercept only the voice content for a VoIP call; 3) able to correlate the CII and CC; 4) able to intercept the CC for a forwarded call; and 5) adhere to the security requirements (any intercept-related process and communication shall be invisible to an unauthorized personnel).

As indicated above and illustrated in FIG. 1, the lawful interception architecture and the specifications in the 3GPP standards presume to have a separate interception for signalling and content for VoIP calls. This approach has a drawback as it does not meet the lawful interception requirements for VoIP call.

The packet cable specifications (US) provide a concept referred to Control Point Discovery (CPD) mechanism in support of content interception for a VoIP call. In this approach, the delivery platform, upon receiving signalling message, launches a message towards the IP end-points identified within the SIP signalling message. The edge router that serves the target subscriber line is expected to respond to that message identifying itself as the possible candidate to provide the CC interception point. The delivery platform then instructs that edge router to provide the CC interception. This approach may meet some of the requirements, but has some risks in meeting the security requirements. Furthermore, under this approach, the CSP is expected to upgrade their network to understand the new message and to ensure that the message is not forwarded to the devices or to the third party equipment that are not authorized to know about interception.

In the European Telecommunications Standards Institute (ETSI) technical committee (TC) on LI, there is an activity under the name Dynamic Triggering with the intent of providing a means for identifying the intercept access node dynamically. This method is more complex and involves a multi-CSP scenario. Furthermore, even in this method one node communicates with another node to trigger the interception dynamically. Accordingly, the potential for security risks are still evident under this method.

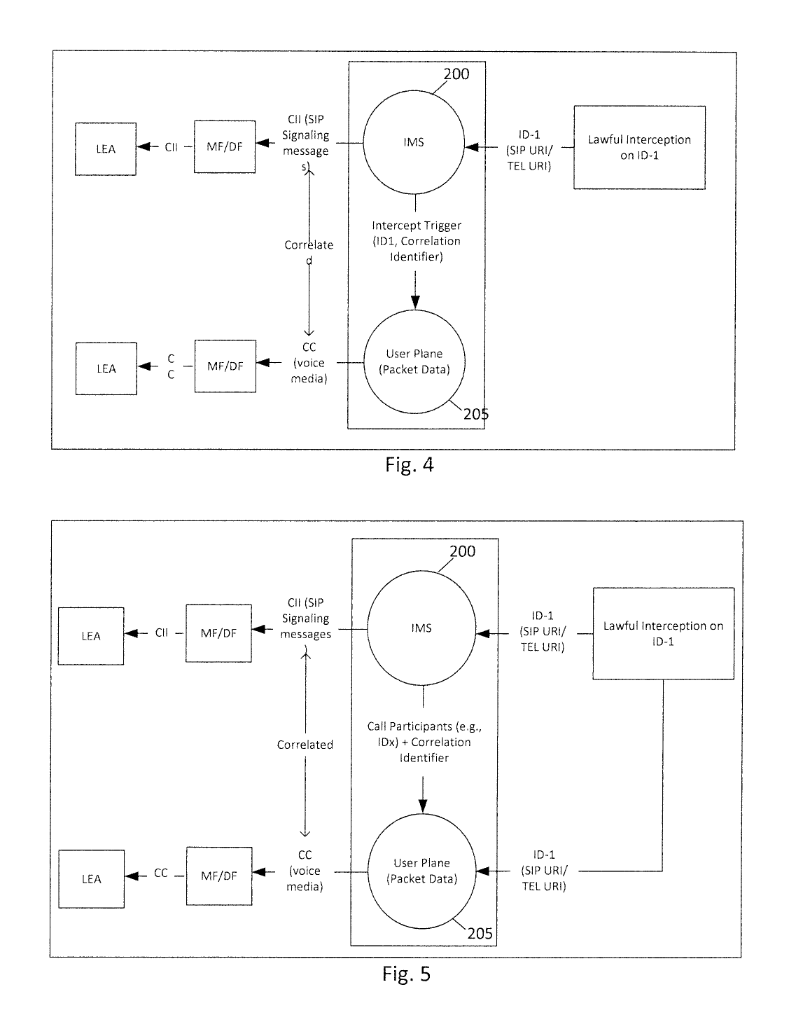

Embodiments of the invention therefore provide mechanisms for overcoming the security risks inherent in prior art approaches. One embodiment is applicable to an implementation for VoIP in which the P-CSCF informs the access node (which can be in the packet core network or it can be outside the packet core network, e.g., Session Border Controller or SBC) to perform the interception on a per call basis with specific header information passed within the signalling messages to signal the access node to perform the interception. This implementation also has intercept access points for the CC interception at the Border Gateways deployed at the egress edge of the network in support of providing interception for forwarded calls. This implementation also provides encryption for the messages exchanged between the two nodes to prevent some unauthorized personnel from knowing about the interception. FIG. 4 illustrates an example of this implementation of lawful interception for VoIP call.

As depicted in FIG. 4, the P-CSCF in the IMS node sends an event (this can as well be adding a parameter to an existing message that is already sent) that includes the instructions to perform the interception and the correlation identifier that has to be used. The security measures may be provided by sending the information for all calls in an encrypted form. One bit within the parameter would tell the access node to perform the interception.

The provisioning of lawful interception is considered to be secure because such a provisioning is done by special nodes and by people who have security clearance. The provisioned data is not maintained in the network nodes that provide the interception in any semi-permanent data. Since the security risks if any has nothing unique to VoIP interception, embodiments of the invention assume that enough security measures are taken as far as provisioning the lawful interception data is concerned.

Some embodiments may be built upon the implementation of VoIP interception outlined above and illustrated in FIG. 4. However, embodiments provide a further layer of security. FIG. 5 illustrates an example of a system implementing an embodiment of the invention. In this embodiment, the identifier (ID) used in the IMS network 200 is provisioned (using the same secured provisioning interface) to all access nodes in the packet core network 205. The access nodes store a list of such provisioned IDs, for example within a local data-base, following the same principle of other nodes that store the lawful interception data. For example, access nodes may store these IDs in the same way as they keep the IDs that apply to packet data interception.

The list of IDs stored by the access nodes may be referred to as a Target List. One difference between the IDs maintained in this Target List and the other IDs is that the access nodes do not use these IDs maintained in the Target List for interception. For example, if SIP URI or the TEL URI is used in the IMS network 200 to intercept the SIP signalling messages, the same ID is provisioned into the access nodes. The access nodes do not use the SIP URI or TEL URI for any of its packet data processing or for any packet data interception.

Then, as a call or session is established, the IMS 200 (e.g., P-CSCF) informs the access node that is on the call. The information can even go to the extent of saying the role played by the IDs. For example, the message may include information to indicate whether the ID is a calling-party, a called-party, or a forwarded-to-party. Alternatively or additionally, the originating end of the IMS may include the ID of the calling party and the terminating end of the IMS may include the ID of the called party. There is no interception related indication in the message. Even if the message-transfer is not protected through some form of protection or encryption, the subject of the message (i.e., interception) cannot be detected because the message simply provides the ID of who is on the call. In this manner, embodiments can provide a secured method of inter-nodal communication for interception purposes without making use of encryption—which can have an impact in reducing the cost of the solution deployment.

When an access node receives the message informing it that a call/session is established, the access node will look at the IDs received in the message from the IMS node and compare the IDs against the Target List. If a match occurs, the access node may start the interception of voice content. There is no other external stimulus necessary to perform the interception. The decision is made locally based on whether a match occurs between the ID received in the message and to an ID stored in the Target List.

Embodiments of the invention are applicable for forwarded call as well as for the original called party (who is presumed to be the target subscriber) is included in the call participants sent to the access node. Embodiments should work with all implementation approaches since the IMS node and the access node are not required to be any particular entity. The call participants and the correlation information can be added to the existing message that is used between the IMS node and the access node in the same way the intercept trigger related information is included within the implementation depicted in FIG. 4. In one embodiment, the IMS node may be the P-CSCF when the calling or called subscriber is an IMS user within the CSP's network and may be an interworking border control function (I-BCF) or media gateway control function (MGCF) when the terminating end of the call happens to be in another network. According to an embodiment, the access node may be the packet data network gateway (PDN-GW) (in LTE), a gateway GPRS support node (GGSN) (in GPRS/UMTS), a border gateway function (BGF) (aka Session Border Controller), a media gateway (MGW) or a transit gateway (TrGW) (aka BGF). It should be noted that embodiments of the invention can be applied for other scenarios (not necessarily just for lawful interception) where similar security risks are involved while passing information from one network node to another network node.

Some embodiments presume that the originating party information is present in the P-Asserted-Identity of the SIP INVITE and terminating party information is present in the REQUEST URI of the SIP INVITE. When an incoming call to a subscriber (referred to as the base-party) to another subscriber (referred to as forwarded-to-party), this embodiment presumes that the base-party information is present in the HISTORY INFO and the forwarded-to-party information is present in the REQUEST URI of SIP INVITE. Other SIP header fields are considered in the event the other SIP header fields identify the originating party, terminating party, base-party, or forwarded-to-party.

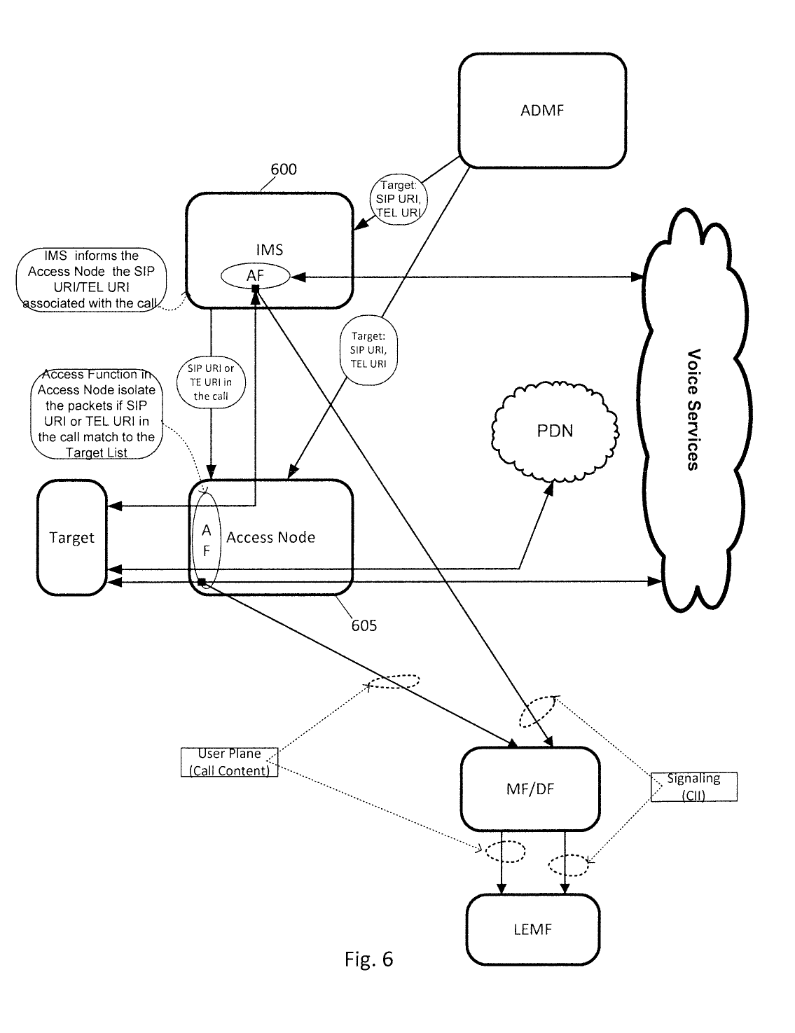

FIG. 6 illustrates a diagram of a system according to an embodiment, for example, where the originating party is the target. As illustrated in FIG. 6, for a basic call, the P-CSCF (in IMS 600) that proxies the SIP messages to and from the SIP user informs the access node 605 (which can be a node in the packet core network, for instance, GGSN, PDN-GW or a BGF (aka Session Border Controller)) with the SIP URI or TEL URI of the subscriber involved in the call. In the case of GGSN and PDN-GW, the interaction may happen via the PCRF. The access node 605 may then compare the SIP URI or the TEL URI against the same stored in the Target List and, if a match occurs, can provide the content interception.

At the originating end of the call, the P-CSCF includes the SIP URI or TEL URI associated with the P-Asserted Identity (used to identify the originating target subscriber) in the call participants list. When the SIP URI or the TEL URI matches to one of the IDs in the Target List, it is determined that the calling subscriber is the target subscriber.

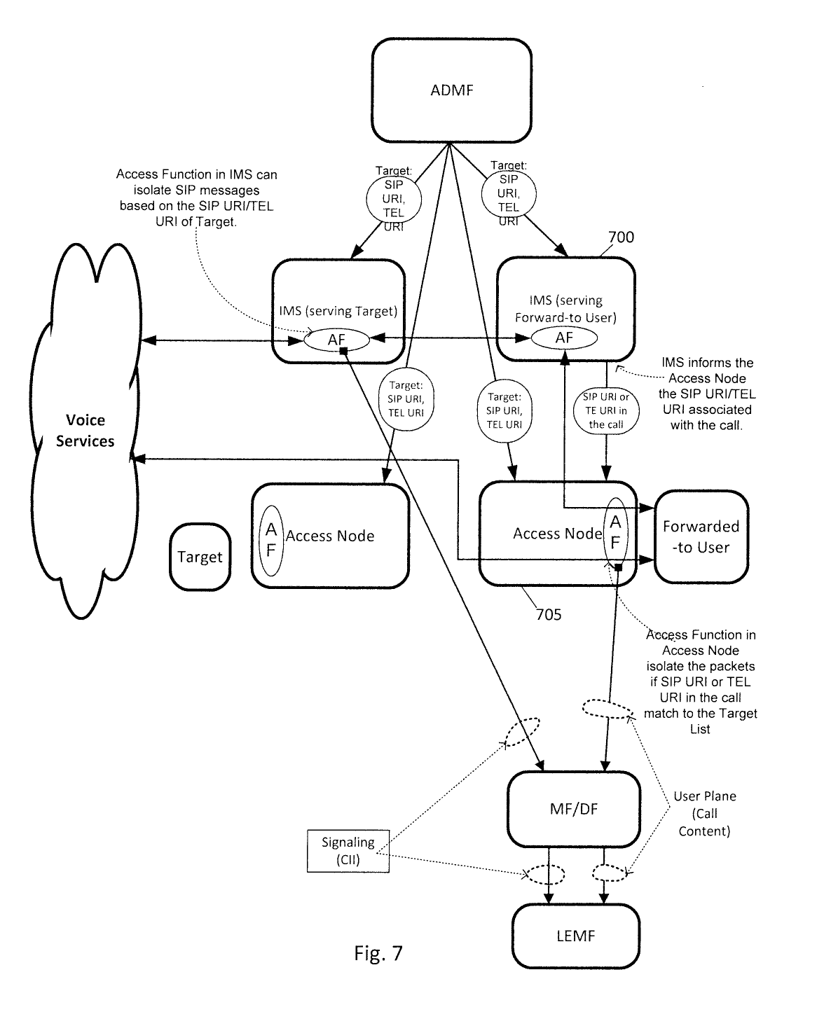

FIG. 7 illustrates a diagram of a system according to an embodiment, for example, where the terminating party is the target. As illustrated in FIG. 7, at the terminating end of the call, the P-CSCF (in IMS 700 serving the forwarded-to user) includes the SIP URI or the TEL URI associated with the REQUEST URI or the URIs present in the HISTORY INFO provided in access node 705. When the SIP URI present in the REQUEST URI matches to one of the IDs in the Target List, it is determined by access node 705 that the subscriber where the call is terminated to happens to be the target subscriber. When the SIP URI present in the HISTORY INFO matches to the Target List, the call is forwarded and one or more of the forwarding subscribers happens to be target subscriber. In the example of FIG. 7 the forward-to subscriber is served by the same CSP.

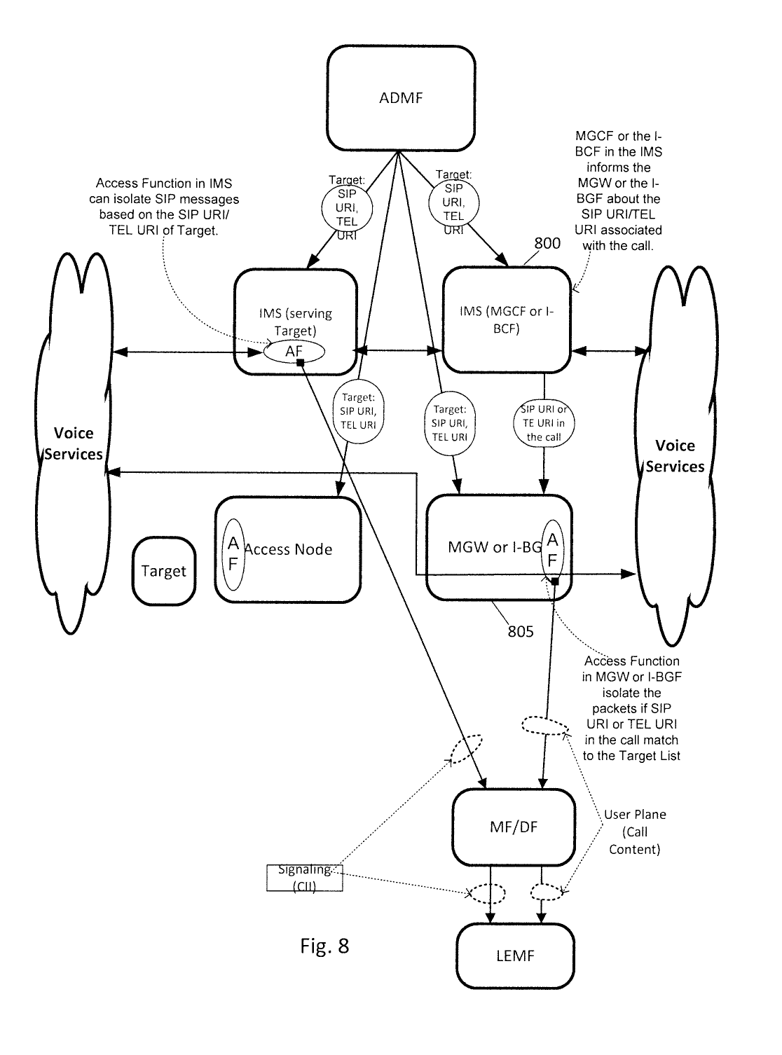

FIG. 8 illustrates a diagram of a system according to an embodiment, for example, where the call is forwarded to a party in another CSP's network. When a call is forwarded to another network, it is presumed that the other network (in other words, the CSP that owns the other network) is responsible for providing the interception functions in the event the called subscriber (being served in that network) happens to be the target subscriber. However, as illustrated in FIG. 8, if a call is terminated to an IMS subscriber served by the CSP is forwarded to another CSP's network, then the I-BCF or the MGCF 800 (depending on whether the other CSP's network is an IMS network or a network in a CS domain) may send the SIP URI or the TEL URI present in the REQUEST URI and the HISTORY INFO to the I-BGF (aka Transit Gateway (TrGW)) or MGW 805. The I-BGF/MGW 805 may then match the SIP or TEL URI against the Target List and provide the voice content interception if a match occurs. It is noted the logic used within the IMS and the access nodes may be basically the same.

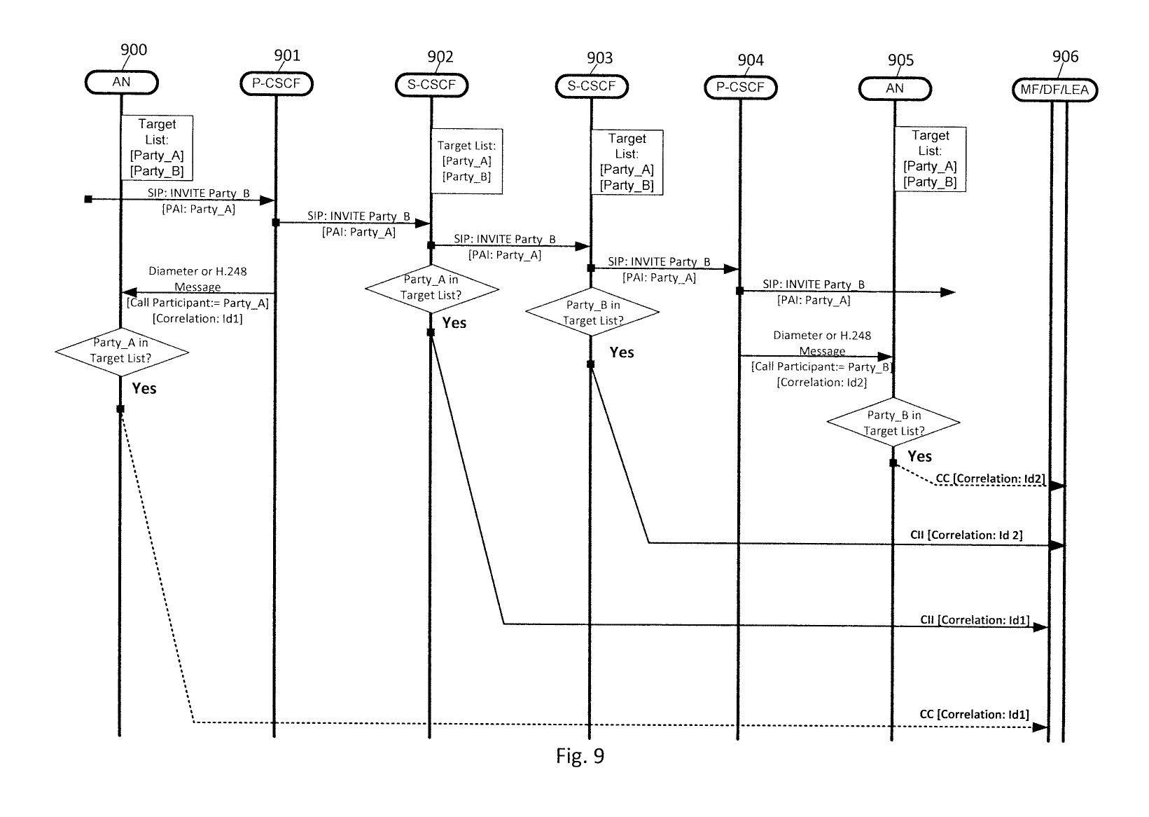

In the embodiments of the call flows described in detail below in FIGS. 9-11, it is presumed that the Correlation Id information is passed from one IMS node to another IMS node within the SIP INVITE message. Additionally, according to certain embodiments, the PCRF may be considered to be part of the access node (AN) within the following presentation of call flows.

According to certain embodiments, which will be discussed in detail in connection with call flow diagrams illustrated in FIGS. 9-11, the originating S-CSCF may check whether the SIP URI or the TEL URI present in the PAI matches the Target List provisioned by the ADMF. The originating P-CSCF or the MGCF or the I-BCF may include the SIP URI or the TEL URI present in the PAI in the call participant list in the message sent to the access node or MGW or the I-BGF. The access node or the MGW or the I-BGF may check the SIP URI or the TEL URI present in the call participant list with the Target List provisioned by the ADMF.

The terminating S-CSCF may check whether the SIP URI or the TEL URI present in the REQUEST URI matches to the Target List provisioned by the ADMF. The terminating P-CSCF or MGCF or the I-BCF may forward the SIP URI or TEL URI present in the REQUEST URI and HISTORY INFO in the call participant list of the message sent to the access node or the MGW or the I-BGF. The access node or the MGW or the I-BGF may check the SIP URI or the TEL URI present in the call participant list with the Target List provisioned by the ADMF.

The following call flows (FIGS. 9-11) illustrate the above points with some examples and/or use-cases.

FIG. 9 illustrates an example call flow diagram for an IMS-to-IMS call within the same CSP, according to an embodiment. In the example of FIG. 9, an IMS subscriber (Party-A) calls another IMS subscriber (Party-B) served by the same CSP. In this example, Party-A (the originating subscriber) and Party-B (the terminating subscriber) happen to be the target of interception. It is noted that the flow does not show all the network nodes (e.g., I-CSCF, HSS, etc.).

Since Party-A (originating subscriber) is the target of interception, the originating side of the access node 900 intercepts the voice content and delivers the same as CC to the LEA via the MF/DF 906. The originating side of the S-CSCF 902 intercepts the signalling information and delivers the same as CII to the LEA via the MF/DF 906. The originating P-CSCF 901 may include the SIP URI or the TEL URI present in the PAI in the call participant list in the message sent to the access node 900. The call flow of FIG. 9 shows that the CII and CC are correlated by using the same identity: Correlation Id1 at the originating side.

Since Party-B (terminating subscriber) is also the target of interception, the terminating side of the access node 905 intercepts the voice content and delivers the same to the LEA via the MF/DF 906. The terminating side of S-CSCF 903 intercepts the signalling information and delivers the same as CII to the LEA via the MF/DF 906. The terminating P-CSCF 904 may include the SIP URI or the TEL URI present in the PAI in the call participant list in the message sent to the access node 905. The call flow shows that the CII and CC are correlated by using the same identity: Correlation Id2 at the terminating side.

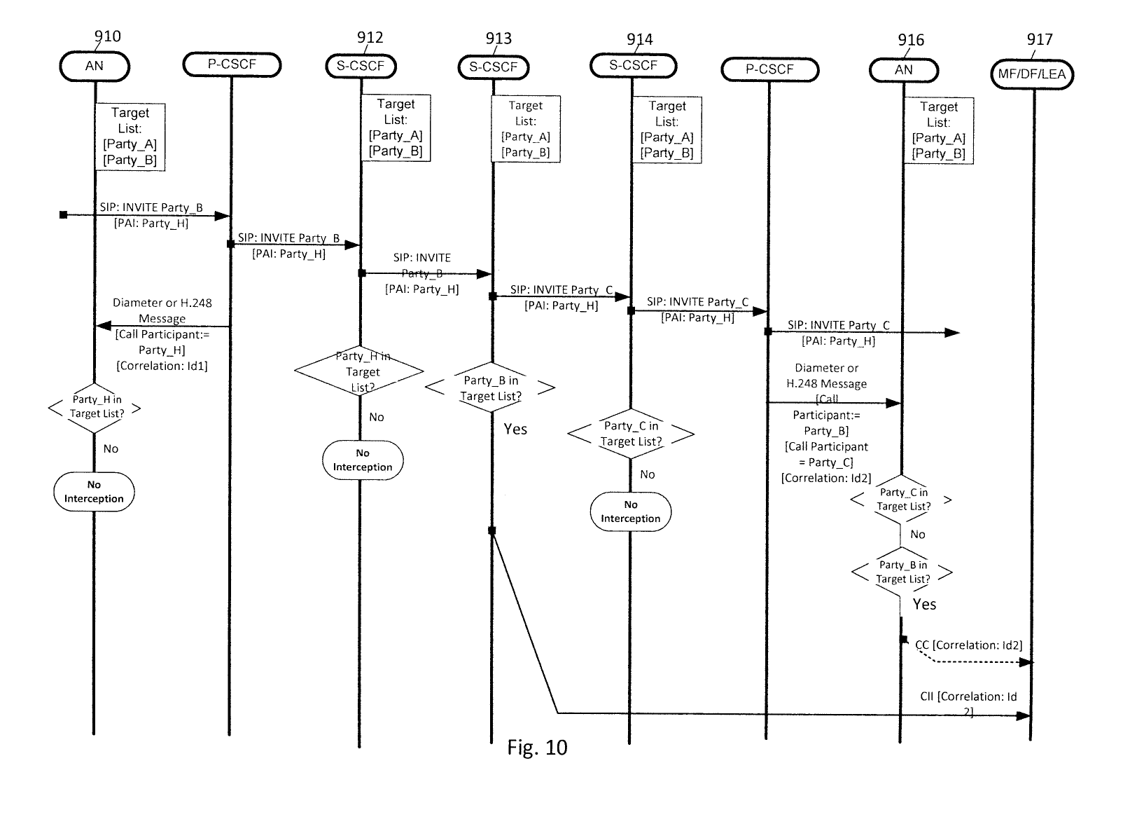

FIG. 10 illustrates an example call flow diagram for IMS-to-IMS call forwarding within the same CSP (i.e., intra-CSP), according to one embodiment. In the example of FIG. 10, an IMS subscriber calls another IMS subscriber who has call forwarding to a third IMS subscriber. All IMS subscribers are served by the same CSP. In this example, Party-H (the originating subscriber) and Party-C (the forwarded-to subscriber) are not the target of interception. The original called subscriber (Party-B) happens to be the target of interception. Again, the flow does not show all the network nodes (e.g., I-CSCF, HSS etc).

Since the Party_H (originating subscriber) is not the target of interception, the originating side of the access node 910 does not intercept the voice content and the originating side of the S-CSCF 912 does not intercept the signalling information.

Further, since the Party_B (original called subscriber) is the target of interception, terminating side of S-CSCF 913 intercepts the signalling information and delivers the same as CII to the LEA via the MF/DF 917. Since the call is forwarded, the access node associated with the Party_B is not involved in the voice-path of the all.

In this example, Party_C (forwarded-to-subscriber) is not the target of interception. However, since the Party_B (the original called subscriber) is the target of interception, the access node 916 associated with the Party_C intercepts the voice content and delivers the same to the LEA via the MF/DF 917. Since the Party_C is not the target of interception, the S-CSCF 914 that serves the Party_C does not intercept the signalling information. Note that the CII (intercepted at the S-CSCF 913 of Party_B) and CC (intercepted at the access node 916 of Party_C) are correlated by using the same identity: Correlation Id2.

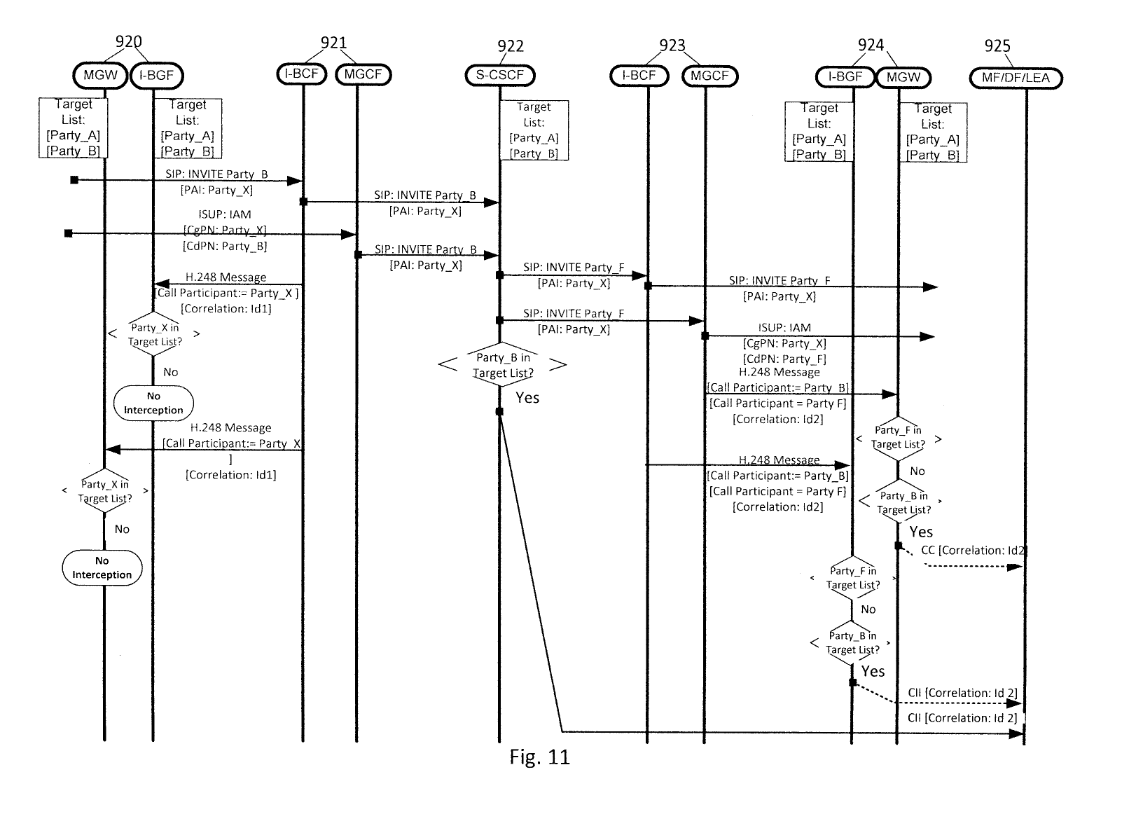

FIG. 11 illustrates an example call flow diagram for inter-CSP call forwarding, according to an embodiment. In the example of FIG. 11, an incoming call (from a different CSP's network) to an IMS subscriber gets forwarded to a subscriber served by a different CSP. In this example, the Party_X (originating subscriber) is served by a different CSP. Also the Party F (the forward-to-subscriber) is served by a different CSP. Party_B that receives the incoming call (but the call gets forwarded) is the target of interception. Party_H and Party_F are considered not to be a target of interception within Party_B's CSP since those subscribers are not served by Party_B's CSP. The call flow of FIG. 11 has four examples built-in: 1) Party_H (IMS) and Party_F (IMS), 2) Party_H (IMS) and Party_F (in CS domain), 3) Party_H (in CS domain) and Party_F (IMS), and 4) Party_H (in CS domain and Party_F (in CS domain). Again, the flow does not show all the network nodes (e.g., I-CSCF, HSS, etc.).

The originating side of the I-BGF or MGW 920 does not intercept the voice content since the Party_X (originating subscriber) is served by a different CSP and thus is not the target of interception. There is similarly no signalling interception in the I-BCF or MGCF 921.

Since the Party_B (original called subscriber) is the target of interception, S-CSCF 922 (in CSP) intercepts the signalling information and delivers the same as CII to the LEA via the MF/DF 925. Since the call is forwarded, the access node associated with the Party_B is not involved in the voice-path of the call.

Party_F is served by a different CSP and therefore is not a target of interception within this CSP's network. However, since the Party_B (the original called subscriber) is the target of interception, the terminating side of I-BGF or MGW 924 intercepts the voice content and delivers the same to the LEA via the MF/DF 925. There is no signalling interception in the I-BCF or MGCF 923. Note that the CII (intercepted at the S-CSCF 922 of Party_B) and CC (intercepted at the terminating side of I-BGF or the MGW 924) are correlated by using the same identity: Correlation Id2.

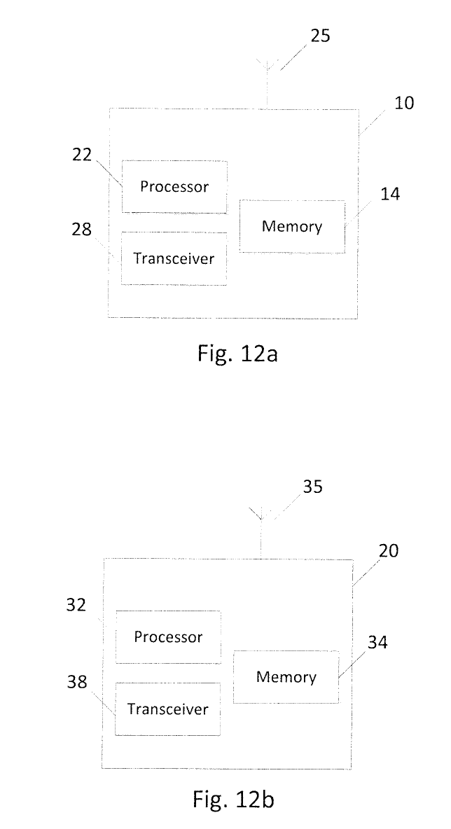

FIG. 12a illustrates an example of an apparatus 10 according to an embodiment. In an embodiment, apparatus 10 may be a node, host, or server in a communications network or serving such a network, such as an access node in a packet core network. It should be noted that one of ordinary skill in the art would understand that apparatus 10 may include components or features not shown in FIG. 12a.

As illustrated in FIG. 12a, apparatus 10 may include a processor 22 for processing information and executing instructions or operations. Processor 22 may be any type of general or specific purpose processor. While a single processor 22 is shown in FIG. 12a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further comprise or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 may be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also comprise or be coupled to one or more antennas 25 for transmitting and receiving signals and/or data to and from apparatus 10. Apparatus 10 may further comprise or be coupled to a transceiver 28 configured to transmit and receive information. The transceiver may be an external device, such as a remote radio head. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

As mentioned above, according to one embodiment, apparatus 10 may be a server, node or host or base station in a communications network or serving such a network, such as an access node in a packet core network. For example, in some embodiments, apparatus 10 may be a PDN-GW, GGSN, BGF, MGW, or TrGW. In one embodiment, apparatus 10 may be controlled by memory 14 and processor 22 to receive one more identities from an IMS node. The identities may be those used by the IMS node to intercept signaling messages. Apparatus 10 may be further controlled by memory 14 and processor 22 to compile a target list comprising the received identities, to and receive a message from the IMS node when a session is established. The message may comprise an identity for each of the parties to the established session. Apparatus 210 may then be controlled by memory 14 and processor 22 to compare the identity for each of the parties to the session with the identities in the target list and, when there is a match between one or more of the identities for each of the parties to the session and any one of the identities in the target list, to intercept call content of the session. In some embodiments, apparatus 10 may be controlled by memory 14 and processor 22 to send the intercepted call content to a MF or DF for forwarding to a LEA.

FIG. 12b illustrates an example of an apparatus 20 according to an embodiment. In an embodiment, apparatus 20 may be a node, host, or server in a communications network or serving such a network, such as a node in IMS. It should be noted that one of ordinary skill in the art would understand that apparatus 20 may include components or features not shown in FIG. 12b.

As illustrated in FIG. 12b, apparatus 20 may include a processor 32 for processing information and executing instructions or operations. Processor 32 may be any type of general or specific purpose processor. While a single processor 32 is shown in FIG. 12b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further comprise or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 may be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

Apparatus 20 may also comprise or be coupled to one or more antennas 35 for transmitting and receiving signals and/or data to and from apparatus 20. Apparatus 20 may further comprise or be coupled to a transceiver 38 configured to transmit and receive information. The transceiver may be an external device, such as a remote radio head. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a server, node or host or base station in a communications network or serving such a network, such as a node in IMS. For example, in some embodiments, apparatus 20 may be a P-CSCF, I-BCF, or MGCF. In one embodiment, apparatus 20 may be controlled by memory 34 and processor 32 to provide, to one or more access nodes, at least one identity used in an internet protocol multimedia system (IMS) to intercept signaling messages. Apparatus 20 may then be controlled by memory 34 and processor 32 to inform at least one of the one or more access nodes when a session is established, for example, by sending a message to the at least one of the one or more access nodes that includes an identity for each of the parties to the session.

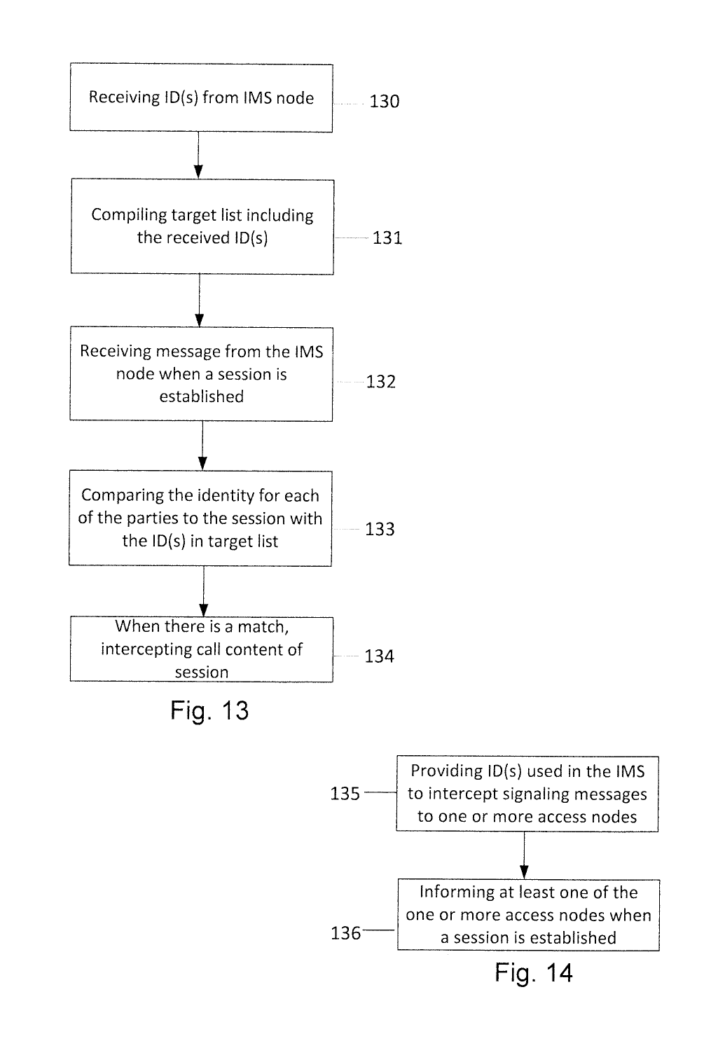

FIG. 13 illustrates an example flow diagram of a method for security of inter-nodal communication for VoIP lawful interception, according to one embodiment. In some embodiments, the method may be performed by an access node in a packet core network. The method may include, at 130, receiving at least one identity from IMS node, the at least one identity being used by the IMS node to intercept signaling messages. The method may then include, at 131, compiling a target list comprising the at least one identity and, at 132, receiving a message from the IMS node when a session is established. The message may include an identity for each of the parties to the session. The method may further include, at 133, comparing the identity for each of the parties to the session with the at least one identity in the target list. When there is a match between any of the identity for each of the parties to the session and any one of the at least one identity in the target list, the method may also include, at 134, intercepting call content of the session.

FIG. 14 illustrates an example flow diagram of a method for security of inter-nodal communication for VoIP lawful interception, according to another embodiment. In some embodiments, the method may be performed by an IMS node. The method may include, at 135, providing, to one or more access nodes, at least one identity used in the IMS to intercept signaling messages. The method may then include, at 136, informing at least one of the one or more access nodes when a session is established, for example, by sending a message to the at least one of the one or more access nodes that includes an identity for each of the parties to the session.

In some embodiments, the functionality of any of the methods described herein, such as that illustrated in FIGS. 13 and 14 discussed above, may be implemented by software and/or computer program code stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

In addition to any advantages outlined above, another advantage according to certain embodiments of the invention is that the actual interception of CII and CC are not dependent on each other. In other words, the call participant information is sent to the access nodes by P-CSCF, I-BCF or MGCF and these nodes are not dependent on where the CII interception is happening From that point of view, the CII interception can be done in the S-CSCF (as defined currently in the 3GPP specifications) or at an Application Server (AS) where most of the voice related features are handled.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method, comprising:
receiving, by an access node, at least one identity from an internet protocol multimedia system (IMS) node, the at least one identity used by the IMS node to intercept signaling messages;
compiling a target list comprising the at least one identity;
receiving a message from the IMS node when a session is established, wherein the message comprises an identity for each of the parties to the session;
comparing the identity for each of the parties to the session with the at least one identity in the target list; and
when there is a match between any of the identity for each of the parties to the session and any one of the at least one identity in the target list, intercepting call content of the session.

2. The method according to claim 1, wherein the intercepting further comprises sending the call content to a mediation function or delivery function for forwarding to a law enforcement authority.

3. The method according to claim 1, wherein the at least one identity comprises at least one of a session initiation protocol (SIP) uniform resource identifier (URI) or a telephone uniform resource identifier (URI).

4. The method according to claim 1, wherein the message further comprises information indicating whether the identity is for a calling party, called party, or forwarded-to party.

5. The method according to claim 1, wherein the message further comprises correlation information.

6. (canceled)

7. (canceled)

8. An apparatus, comprising:
at least one processor; and
at least one memory including computer program code,
wherein the at least one memory and the computer program code are configured, with the at least one processor, to cause the apparatus at least to
receive at least one identity from an internet protocol multimedia system (IMS) node, the at least one identity used by the IMS node to intercept signaling messages;
compile a target list comprising the at least one identity;
receive a message from the IMS node when a session is established, wherein the message comprises an identity for each of the parties to the session;
compare the identity for each of the parties to the session with the at least one identity in the target list; and
when there is a match between any of the identity for each of the parties to the session and any one of the at least one identity in the target list, intercept call content of the session.

9. The apparatus according to claim 8, wherein the at least one memory and the computer program code are further configured, with the at least one processor, to cause the apparatus at least to send the call content to a mediation function or delivery function for forwarding to a law enforcement authority.

10. The apparatus according to claim 8, wherein the at least one identity comprises at least one of a session initiation protocol (SIP) uniform resource identifier (URI) or a telephone uniform resource identifier (URI).

11. The apparatus according to claim 8, wherein the message further comprises information indicating whether the identity is for a calling party, called party, or forwarded-to party.

12. The apparatus according to claim 8, wherein the message further comprises correlation information.

13-15. (canceled)

16. A computer program product, embodied on a computer readable medium, the computer program product configured to control a processor to perform a method according to claim 1.

17. A method, comprising:
providing, by an internet protocol multimedia system (IMS) node, at least one identity used in the IMS to intercept signaling messages to one or more access nodes; and
informing at least one of the one or more access nodes when a session is established,
wherein the informing comprises sending a message to the at least one of the one or more access nodes, wherein the message comprises an identity for each of the parties to the session.

18. The method according to claim 17, wherein the at least one identity comprises at least one of a session initiation protocol (SIP) uniform resource identifier (URI) or a telephone uniform resource identifier (URI).

19. The method according to claim 17, wherein the message further comprises information indicating whether the identity is for a calling party, called party, or forwarded-to party.

20. The method according to claim 17, wherein the message further comprises correlation information.

21. The method according to claim 17, wherein the access nodes comprise at least one of a packet data network gateway (PDN-GW), a gateway generic packet radio service support node (GGSN), a border gateway function (BGF), media gateway (MGW), or transit gateway (TrGW).

22. The method according to claim 17, wherein the IMS node comprises at least one of a proxy call state control function (P-CSCF), an interworking border control function (I-BCF), or a Media Gateway Control Function (MGCF).

23. An apparatus, comprising:
at least one processor; and
at least one memory including computer program code,
wherein the at least one memory and the computer program code are configured, with the at least one processor, to cause the apparatus at least to
provide, to one or more access nodes, at least one identity used in an internet protocol multimedia system (IMS) to intercept signaling messages; and
inform at least one of the one or more access nodes when a session is established,
wherein the informing comprises sending a message to the at least one of the one or more access nodes, wherein the message comprises an identity for each of the parties to the session.

24. The apparatus according to claim 23, wherein the at least one identity comprises at least one of a session initiation protocol (SIP) uniform resource identifier (URI) or a telephone uniform resource identifier (URI).

25. The apparatus according to claim 23, wherein the message further comprises information indicating whether the identity is for a calling party, called party, or forwarded-to party.

26. The apparatus according to claim 23, wherein the message further comprises correlation information.

27. The apparatus according to claim 23, wherein the access nodes comprise at least one of a packet data network gateway (PDN-GW), a gateway generic packet radio service support node (GGSN), a border gateway function (BGF), media gateway (MGW), or transit gateway (TrGW).

28. The apparatus according to claim 23, wherein the apparatus comprises at least one of a proxy call state control function (P-CSCF), an interworking border control function (I-BCF), or a Media Gateway Control Function (MGCF).

29. (canceled)

30. A computer program product, embodied on a non-transitory computer readable medium, the computer program product configured to control a processor to perform a method according to claim 17.
